(19) United States
(12) Patent Application Publication
(10) Pub. No.: US 2020/0068195 A1
(43) Pub. Date: Feb. 27, 2020

(54) FREQUENCY DOMAIN FILTERING METHOD IN IMAGE CODING SYSTEM, AND DEVICE THEREFOR

(71) Applicant: LG ELECTRONICS INC., Seoul (KR)

(72) Inventors: Sunmi YOO, Seoul (KR); Seunghwan KIM, Seoul (KR); Jin HEO, Seoul (KR); Seethal PALURI, Seoul (KR)

(21) Appl. No.: 16/610,829

(22) PCT Filed: Feb. 5, 2018
(86) PCT No.: PCT/KR2018/001495

§ 371 Date: Nov. 4, 2019

Related U.S. Application Data
(60) Provisional application No. 62/506,577, filed on May 15, 2017.

(51) Int. Cl. H04N 19/117; H04N 19/176; H04N 19/129; H04N 19/593

(52) U.S. Cl. CPC H04N 19/117; H04N 19/593; H04N 19/129; H04N 19/176

(57) ABSTRACT

A prediction method according to the present invention comprises the steps of: deriving a prediction block on the basis of an intra prediction mode; deriving transform coefficients of the prediction block by applying transformation to the prediction block; applying frequency domain filtering to the transform coefficients of the prediction block; and generating a modified prediction block by applying inverse transformation on modified transform coefficients derived through the frequency domain filtering, wherein prediction performance can be improved thereby and the amount of data required for residual coding can be reduced.

### CROSS-REFERENCE TO RELATED APPLICATIONS

This application is the National Stage filing under 35 U.S.C. 371 of International Application No. PCT/KR2018/001495, filed on Feb. 5, 2018, which claims the benefit of U.S. Provisional Application No. 62/506,577 filed on May 15, 2017, the contents of which are all hereby incorporated by reference herein in their entirety.

### TECHNICAL FIELD

The embodiment relates to an image coding technique and, more particularly, to a frequency domain filtering method in an image coding system and a device therefor.

### BACKGROUND

Demand for high-resolution, high-quality images such as HD (High Definition) images and UHD (Ultra High Definition) images have been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY

An aspect of the disclosure is to provide a method and a device for enhancing image coding efficiency.

Another aspect of the disclosure is to provide a method and a device for enhancing prediction performance through frequency domain filtering.

Still another aspect of the disclosure is to provide a method and a device for efficiently removing a high-frequency error or noise component.

According to one embodiment of the disclosure, there is provided a prediction method performed by a decoding device. The method includes: deriving a prediction block based on an intra-prediction mode; deriving transform coefficients for the prediction block by applying transformation to the prediction block; applying frequency domain filtering to the transform coefficients for the prediction block; and generating a modified prediction block by applying inverse transformation to modified transform coefficients derived through the frequency domain filtering.

According to another embodiment of the disclosure, there is provided an image decoding device performing prediction. The decoding device includes: an intra-predictor configured to derive a prediction block based on an intra-prediction mode; a transformer configured to derive transform coefficients for the prediction block by applying transformation to the prediction block; a filter configured to apply frequency domain filtering to the transform coefficients for the prediction block; and an inverse transformer configured to generate a modified prediction block by applying inverse transformation to modified transform coefficients derived through the frequency domain filtering.

According to still another embodiment of the disclosure, there is provided a prediction method performed by an encoding device. The method includes: deriving a prediction block based on an intra-prediction mode; deriving transform coefficients for the prediction block by applying transformation to the prediction block; applying frequency domain filtering to the transform coefficients for the prediction block; and generating a modified prediction block by applying inverse transformation to modified transform coefficients derived through the frequency domain filtering.

According to yet another embodiment of the disclosure, there is provided an image encoding device performing a prediction method. The encoding device includes: an intra-predictor configured to derive a prediction block based on an intra-prediction mode; a transformer configured to derive transform coefficients for the prediction block by applying transformation to the prediction block; a filter configured to apply frequency domain filtering to the transform coefficients for the prediction block; and an inverse transformer configured to generate a modified prediction block by applying inverse transformation to modified transform coefficients derived through the frequency domain filtering.

According to the disclosure, it is possible to enhance overall image/video compression efficiency.

According to the disclosure, it is possible to enhance prediction performance through frequency domain filtering and to reduce the amount of data required for residual coding.

According to the disclosure, it is possible to efficiently reduce a high-frequency error component.

### BRIEF DESCRIPTION OF THE DRAWINGS

FIG. 1 schematically illustrates a configuration of a video encoding device to which the present embodiment is applicable.

FIG. 2 schematically illustrates a configuration of a video decoding device to which the present embodiment is applicable.

FIG. 3 illustrates an example of a frequency domain filtering method by an encoding device.

FIG. 4 illustrates an example of a frequency domain filtering method by a decoding device.

FIG. 5 illustrates another example of a frequency domain filtering method.

FIG. 6 illustrates still another example of a frequency domain filtering method.

FIG. 7 schematically illustrates a video/image encoding method including a frequency domain filtering method according to the disclosure.

FIG. 8 schematically illustrates a video/image decoding method including a frequency domain filtering method according to the disclosure.

### DESCRIPTION OF EXEMPLARY EMBODIMENTS

The present embodiment may be modified in various forms, and specific examples thereof will be described and illustrated in the drawings. However, the examples are not intended for limiting the embodiment. The terms used in the following description are used to merely describe specific examples, but are not intended to limit the embodiment. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, elements in the drawings described in the embodiment are independently drawn for the purpose of convenience for explanation of different specific functions, and do not mean that the elements are embodied by independent hardware or independent software. For example, two or more elements of the elements may be combined to form a single element, or one element may be divided into plural elements. The examples in which the elements are combined and/or divided belong to the embodiment without departing from the concept of the embodiment.

Hereinafter, embodiments of the present embodiment will be described in detail with reference to the accompanying drawings. In addition, like reference numerals are used to indicate like elements throughout the drawings, and the same descriptions on the like elements will be omitted.

In the present specification, generally a picture means a unit representing an image at a specific time, a slice is a unit constituting a part of the picture. One picture may be composed of plural slices, and the terms of a picture and a slice may be mixed with each other as occasion demands.

A pixel or a pel may mean a minimum unit constituting one picture (or image). Further, a “sample” may be used as a term corresponding to a pixel. The sample may generally represent a pixel or a value of a pixel, may represent only a pixel (a pixel value) of a luma component, and may represent only a pixel (a pixel value) of a chroma component.

A unit indicates a basic unit of image processing. The unit may include at least one of a specific area and information related to the area. Optionally, the unit may be mixed with terms such as a block, an area, or the like. In a typical case, an M×N block may represent a set of samples or transform coefficients arranged in M columns and N rows.

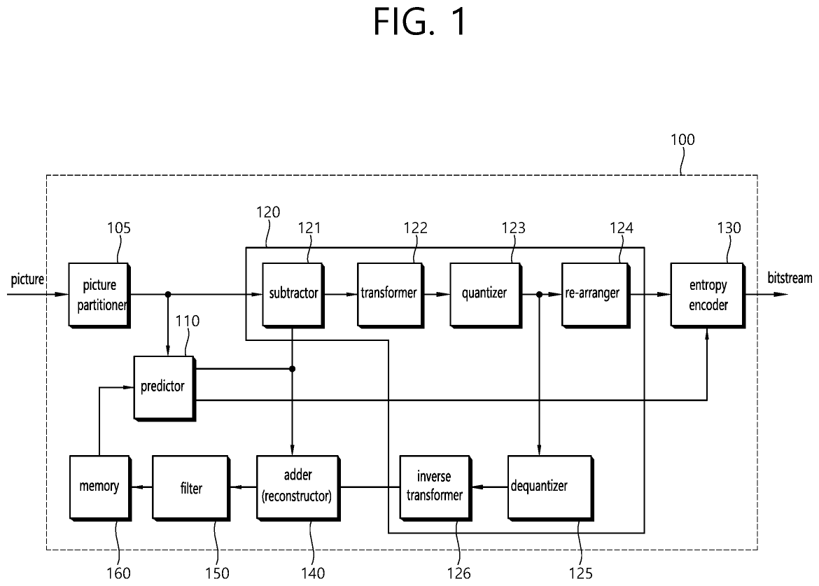

FIG. 1 schematically illustrates a configuration of a video encoding device to which the present embodiment is applicable.

Referring to FIG. 1, a video encoding device 100 may include a picture partitioner 105, a predictor 110, a residual processor 120, an adder 140, a filter 150, and a memory 160. The residual processor 120 may include a subtractor 121, a transformer 122, a quantizer 123, a re-arranger 124, a dequantizer 125, an inverse transformer 126.

The picture partitioner 105 may split an input picture into at least one processing unit.

In an example, the processing unit may be referred to as a coding unit (CU). In this case, the coding unit may be recursively split from the largest coding unit (LCU) according to a quad-tree binary-tree (QTBT) structure. For example, one coding unit may be split into a plurality of coding units of a deeper depth based on a quadtree structure and/or a binary tree structure. In this case, for example, the quad tree structure may be first applied and the binary tree structure may be applied later. Alternatively, the binary tree structure may be applied first. The coding procedure according to the present embodiment may be performed based on a final coding unit which is not split any further. In this case, the largest coding unit may be used as the final coding unit based on coding efficiency, or the like, depending on image characteristics, or the coding unit may be recursively split into coding units of a lower depth as necessary and a coding unit having an optimal size may be used as the final coding unit. Here, the coding procedure may include a procedure such as prediction, transformation, and reconstruction, which will be described later.

In another example, the processing unit may include a coding unit (CU) prediction unit (PU), or a transform unit (TU). The coding unit may be split from the largest coding unit (LCU) into coding units of a deeper depth according to the quad tree structure. In this case, the largest coding unit may be directly used as the final coding unit based on the coding efficiency, or the like, depending on the image characteristics, or the coding unit may be recursively split into coding units of a deeper depth as necessary and a coding unit having an optimal size may be used as a final coding unit. When the smallest coding unit (SCU) is set, the coding unit may not be split into coding units smaller than the smallest coding unit. Here, the final coding unit refers to a coding unit which is partitioned or split to a prediction unit or a transform unit. The prediction unit is a unit which is partitioned from a coding unit, and may be a unit of sample prediction. Here, the prediction unit may be divided into sub-blocks. The transform unit may be divided from the coding unit according to the quad-tree structure and may be a unit for deriving a transform coefficient and/or a unit for deriving a residual signal from the transform coefficient. Hereinafter, the coding unit may be referred to as a coding block (CB), the prediction unit may be referred to as a prediction block (PB), and the transform unit may be referred to as a transform block (TB). The prediction block or prediction unit may refer to a specific area in the form of a block in a picture and include an array of prediction samples. Also, the transform block or transform unit may refer to a specific area in the form of a block in a picture and include the transform coefficient or an array of residual samples. Also, a coding unit, a prediction unit, a transform unit may be used separately, or a coding unit may be used by unifying concepts of a prediction unit, a transform unit and a coding unit without separating it.

The predictor 110 may perform prediction on a processing target block (hereinafter, a current block), and may generate a predicted block including prediction samples for the current block. A unit of prediction performed in the predictor 110 may be a coding block, or may be a transform block, or may be a prediction block.

The predictor 110 may determine whether intra-prediction is applied or inter-prediction is applied to the current block. For example, the predictor 110 may determine whether the intra-prediction or the inter-prediction is applied in unit of CU.

In case of the intra-prediction, the predictor 110 may derive a prediction sample for the current block based on a reference sample outside the current block in a picture to which the current block belongs (hereinafter, a current picture). In this case, the predictor 110 may derive the prediction sample based on an average or interpolation of neighboring reference samples of the current block (case (i)), or may derive the prediction sample based on a reference sample existing in a specific (prediction) direction as to a prediction sample among the neighboring reference samples of the current block (case (ii)). The case (i) may be called a non-directional mode or a non-angular mode, and the case (ii) may be called a directional mode or an angular mode. In the intra-prediction, prediction modes may include as an example 33 directional modes and at least two non-directional modes. The non-directional modes may include DC mode and planar mode. The predictor 110 may determine the prediction mode to be applied to the current block by using the prediction mode applied to the neighboring block.

In case of the inter-prediction, the predictor 110 may derive the prediction sample for the current block based on a sample specified by a motion vector on a reference picture. The predictor 110 may derive the prediction sample for the current block by applying any one of a skip mode, a merge mode, and a motion vector prediction (MVP) mode. In case of the skip mode and the merge mode, the predictor 110 may use motion information of the neighboring block as motion information of the current block. In case of the skip mode, unlike in the merge mode, a difference (residual) between the prediction sample and an original sample is not transmitted. In case of the MVP mode, a motion vector of the neighboring block is used as a motion vector predictor and thus is used as a motion vector predictor of the current block to derive a motion vector of the current block.

In case of the inter-prediction, the neighboring block may include a spatial neighboring block existing in the current picture and a temporal neighboring block existing in the reference picture. The reference picture including the temporal neighboring block may also be called a collocated picture (colPic). Motion information may include the motion vector and a reference picture index. Information such as prediction mode information and motion information may be (entropy) encoded, and then output as a form of a bitstream.

When motion information of a temporal neighboring block is used in the skip mode and the merge mode, a highest picture in a reference picture list may be used as a reference picture. Reference pictures included in the reference picture list may be aligned based on a picture order count (POC) difference between a current picture and a corresponding reference picture. A POC corresponds to a display order and may be discriminated from a coding order.

The subtractor 121 generates a residual sample which is a difference between an original sample and a prediction sample. If the skip mode is applied, the residual sample may not be generated as described above.

The transformer 122 transforms residual samples in units of a transform block to generate a transform coefficient. The transformer 122 may perform transformation based on the size of a corresponding transform block and a prediction mode applied to a coding block or prediction block spatially overlapping with the transform block. For example, residual samples may be transformed using discrete sine transform (DST) kernel if intra-prediction is applied to the coding block or the prediction block overlapping with the transform block and the transform block is a 4×4 residual array and is transformed using discrete cosine transform (DCT) kernel in other cases.

The quantizer 123 may quantize the transform coefficients to generate quantized transform coefficients.

The re-arranger 124 rearranges quantized transform coefficients. The re-arranger 124 may rearrange the quantized transform coefficients in the form of a block into a one-dimensional vector through a coefficient scanning method. Although the re-arranger 124 is described as a separate component, the re-arranger 124 may be a part of the quantizer 123.

The entropy encoder 130 may perform entropy-encoding on the quantized transform coefficients. The entropy encoding may include an encoding method, for example, an exponential Golomb, a context-adaptive variable length coding (CAVLC), a context-adaptive binary arithmetic coding (CABAC), or the like. The entropy encoder 130 may perform entropy encoding or predetermined-method encoding together or separately on information (e.g., a syntax element value or the like) required for video reconstruction in addition to the quantized transform coefficients. The encoded information may be transmitted or stored in unit of a network abstraction layer (NAL) in a bitstream form.

The dequantizer 125 dequantizes values (transform coefficients) quantized by the quantizer 123 and the inverse transformer 126 inversely transforms values dequantized by the dequantizer 125 to generate a residual sample.

The adder 140 adds a residual sample to a prediction sample to reconstruct a picture. The residual sample may be added to the prediction sample in units of a block to generate a reconstructed block. Although the adder 140 is described as a separate component, the adder 140 may be a part of the predictor 110. Meanwhile, the adder 140 may be referred to as a reconstructor or reconstructed block generator.

The filter 150 may apply deblocking filtering and/or a sample adaptive offset to the reconstructed picture. Artifacts at a block boundary in the reconstructed picture or distortion in quantization may be corrected through deblocking filtering and/or sample adaptive offset. Sample adaptive offset may be applied in units of a sample after deblocking filtering is completed. The filter 150 may apply an adaptive loop filter (ALF) to the reconstructed picture. The ALF may be applied to the reconstructed picture to which deblocking filtering and/or sample adaptive offset has been applied.

The memory 160 may store a reconstructed picture (decoded picture) or information necessary for encoding/decoding. Here, the reconstructed picture may be the reconstructed picture filtered by the filter 150. The stored reconstructed picture may be used as a reference picture for (inter) prediction of other pictures. For example, the memory 160 may store (reference) pictures used for inter-prediction. Here, pictures used for inter-prediction may be designated according to a reference picture set or a reference picture list.

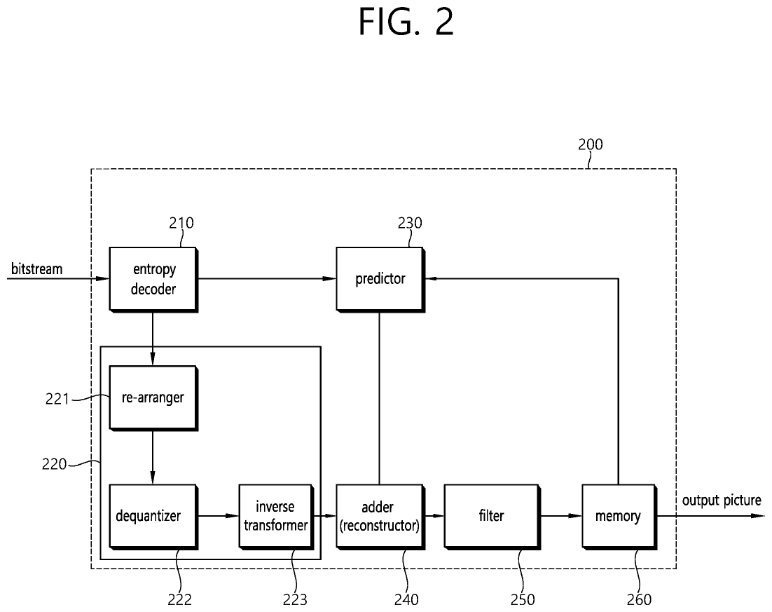

FIG. 2 schematically illustrates a configuration of a video decoding device to which the present embodiment is applicable.

Referring to FIG. 2, a video decoding device 200 may include an entropy decoder 210, a residual processor 220, a predictor 230, an adder 240, a filter 250, and a memory 260. The residual processor 220 may include a re-arranger 221, a dequantizer 222, an inverse transformer 223. Although not illustrated in the drawings, the video decoding device 200 may include a receiver for receiving a bitstream including video information. The receiver may be configured as a separate module or may be included in the entropy decoder 210.

When a bitstream including video information is input, the video decoding device 200 may reconstruct a video in association with a process by which video information is processed in the video encoding device.

For example, the video decoding device 200 may perform video decoding using a processing unit applied in the video encoding device. Thus, the processing unit block of video decoding may be, for example, a coding unit and, in another example, a coding unit, a prediction unit or a transform unit. The coding unit may be split from the largest coding unit according to the quad tree structure and/or the binary tree structure.

A prediction unit and a transform unit may be further used in some cases, and in this case, the prediction block is a block derived or partitioned from the coding unit and may be a unit of sample prediction. Here, the prediction unit may be divided into sub-blocks. The transform unit may be split from the coding unit according to the quad tree structure and may be a unit that derives a transform coefficient or a unit that derives a residual signal from the transform coefficient.

The entropy decoder 210 may parse the bitstream to output information required for video reconstruction or picture reconstruction. For example, the entropy decoder 210 may decode information in the bitstream based on a coding method such as exponential Golomb encoding, CAVLC, CABAC, or the like, and may output a value of a syntax element required for video reconstruction and a quantized value of a transform coefficient regarding a residual.

More specifically, a CABAC entropy decoding method may receive a bin corresponding to each syntax element in a bitstream, determine a context model using decoding target syntax element information and decoding information of neighboring and decoding target blocks or information of amabol/bin decoded in a previous step, predict bin generation probability according to the determined context model and perform arithmetic decoding of the bin to generate a symbol corresponding to each syntax element value. Here, the CABAC entropy decoding method may update the context model using information of a symbol/bin decoded for a context model of the next symbol/bin after determination of the context model.

Information about prediction among information decoded in the entropy decoder 210 may be provided to the predictor 250 and residual values, that is, quantized transform coefficients, on which entropy decoding has been performed by the entropy decoder 210 may be input to the re-arranger 221.

The re-arranger 221 may rearrange the quantized transform coefficients into a two-dimensional block form. The re-arranger 221 may perform rearrangement corresponding to coefficient scanning performed by the encoding device. Although the re-arranger 221 is described as a separate component, the re-arranger 221 may be a part of the dequantizer 222.

The dequantizer 222 may de-quantize the quantized transform coefficients based on a (de)quantization parameter to output a transform coefficient. In this case, information for deriving a quantization parameter may be signaled from the encoding device.

The inverse transformer 223 may inverse-transform the transform coefficients to derive residual samples.

The predictor 230 may perform prediction on a current block, and may generate a predicted block including prediction samples for the current block. A unit of prediction performed in the predictor 230 may be a coding block or may be a transform block or may be a prediction block.

The predictor 230 may determine whether to apply intra-prediction or inter-prediction based on information on a prediction. In this case, a unit for determining which one will be used between the intra-prediction and the inter-prediction may be different from a unit for generating a prediction sample. In addition, a unit for generating the prediction sample may also be different in the inter-prediction and the intra-prediction. For example, which one will be applied between the inter-prediction and the intra-prediction may be determined in unit of CU. Further, for example, in the inter-prediction, the prediction sample may be generated by determining the prediction mode in unit of PU, and in the intra-prediction, the prediction sample may be generated in unit of TU by determining the prediction mode in unit of PU.

In case of the intra-prediction, the predictor 230 may derive a prediction sample for a current block based on a neighboring reference sample in a current picture. The predictor 230 may derive the prediction sample for the current block by applying a directional mode or a non-directional mode based on the neighboring reference sample of the current block. In this case, a prediction mode to be applied to the current block may be determined by using an intra-prediction mode of a neighboring block.

In the case of inter-prediction, the predictor 230 may derive a prediction sample for a current block based on a sample specified in a reference picture according to a motion vector. The predictor 230 may derive the prediction sample for the current block using one of the skip mode, the merge mode and the MVP mode. Here, motion information required for inter-prediction of the current block provided by the video encoding device, for example, a motion vector and information about a reference picture index may be acquired or derived based on the information about prediction.

In the skip mode and the merge mode, motion information of a neighboring block may be used as motion information of the current block. Here, the neighboring block may include a spatial neighboring block and a temporal neighboring block.

The predictor 230 may construct a merge candidate list using motion information of available neighboring blocks and use information indicated by a merge index on the merge candidate list as a motion vector of the current block. The merge index may be signaled by the encoding device. Motion information may include a motion vector and a reference picture. When motion information of a temporal neighboring block is used in the skip mode and the merge mode, a highest picture in a reference picture list may be used as a reference picture.

In the case of the skip mode, a difference (residual) between a prediction sample and an original sample is not transmitted, distinguished from the merge mode.

In the case of the MVP mode, the motion vector of the current block may be derived using a motion vector of a neighboring block as a motion vector predictor. Here, the neighboring block may include a spatial neighboring block and a temporal neighboring block.

When the merge mode is applied, for example, a merge candidate list may be generated using a motion vector of a reconstructed spatial neighboring block and/or a motion vector corresponding to a Col block which is a temporal neighboring block. A motion vector of a candidate block selected from the merge candidate list is used as the motion vector of the current block in the merge mode. The aforementioned information about prediction may include a merge index indicating a candidate block having the best motion vector selected from candidate blocks included in the merge candidate list. Here, the predictor 230 may derive the motion vector of the current block using the merge index.

When the MVP (Motion vector Prediction) mode is applied as another example, a motion vector predictor candidate list may be generated using a motion vector of a reconstructed spatial neighboring block and/or a motion vector corresponding to a Col block which is a temporal neighboring block. That is, the motion vector of the reconstructed spatial neighboring block and/or the motion vector corresponding to the Col block which is the temporal neighboring block may be used as motion vector candidates. The aforementioned information about prediction may include a prediction motion vector index indicating the best motion vector selected from motion vector candidates included in the list. Here, the predictor 230 may select a prediction motion vector of the current block from the motion vector candidates included in the motion vector candidate list using the motion vector index. The predictor of the encoding device may obtain a motion vector difference (MVD) between the motion vector of the current block and a motion vector predictor, encode the MVD and output the encoded MVD in the form of a bitstream. That is, the MVD may be obtained by subtracting the motion vector predictor from the motion vector of the current block. Here, the predictor 230 may acquire a motion vector included in the information about prediction and derive the motion vector of the current block by adding the motion vector difference to the motion vector predictor. In addition, the predictor may obtain or derive a reference picture index indicating a reference picture from the aforementioned information about prediction.

The adder 240 may add a residual sample to a prediction sample to reconstruct a current block or a current picture. The adder 240 may reconstruct the current picture by adding the residual sample to the prediction sample in units of a block. When the skip mode is applied, a residual is not transmitted and thus the prediction sample may become a reconstructed sample. Although the adder 240 is described as a separate component, the adder 240 may be a part of the predictor 230. Meanwhile, the adder 240 may be referred to as a reconstructor or reconstructed block generator.

The filter 250 may apply deblocking filtering, sample adaptive offset and/or ALF to the reconstructed picture. Here, sample adaptive offset may be applied in units of a sample after deblocking filtering. The ALF may be applied after deblocking filtering and/or application of sample adaptive offset.

The memory 260 may store a reconstructed picture (decoded picture) or information necessary for decoding. Here, the reconstructed picture may be the reconstructed picture filtered by the filter 250. For example, the memory 260 may store pictures used for inter-prediction. Here, the pictures used for inter-prediction may be designated according to a reference picture set or a reference picture list. A reconstructed picture may be used as a reference picture for other pictures. The memory 260 may output reconstructed pictures in an output order.

As described above, in performing video coding, prediction is performed to increase compression efficiency. Accordingly, it is possible to generate a prediction block including prediction samples for a current block that is a block to be coded. Here, the prediction block includes prediction samples in a spatial domain (or pixel domain). The prediction block is derived equally by an encoding device and a decoding device, and the encoding device may signal information about a residual between an original block and the prediction block (residual information), instead of an original sample value of the original block, to the decoding device, thereby increasing image coding efficiency. The decoding device may derive a residual block including residual samples based on the residual information, may generate a reconstructed block including reconstructed samples by adding the residual block and the prediction block, and may generate a reconstructed picture including reconstruction blocks.

When intra-prediction is performed, since there is limited information for reference, the accuracy of intra-prediction may be lower than that of inter-prediction. When the prediction accuracy is low, the quantity of residual signals (or residual data) inevitably increases, which may lead to an increase in overall bit rate. Particularly, in designing a hardware decoder, the longest time is generally required for decoding due to the quantity of intra-residual signals, and therefore it is necessary to design an efficient intra-prediction method.

Although data to be transmitted may be simplified by efficiently conversion of residual signals, which is limited in terms of complexity and general use, it is more efficient to reduce the quantity of residual signals by increasing prediction accuracy. Intra-post-filtering has been studied as a method for increasing prediction accuracy using limited information. Intra-post-filtering is a method of applying filtering to a prediction block after intra prediction is completed. For example, as an intra-post-filtering method, there is a method of removing/mitigating discontinuity by applying smooth filtering to a region where discontinuity occurs between prediction samples of a prediction block and neighboring samples (neighboring pixels) in view of a prediction direction. In intra-prediction, prediction may be performed using only an upper neighboring reference sample or only a left neighboring reference sample according to the prediction direction, such as a vertical mode or a horizontal mode. For example, assuming that a block is intra-predicted in the vertical mode, prediction samples in a prediction block do not refer to a left neighboring reference sample, and thus noticeable discontinuity may occur at a left boundary. In this case, a smoothing filter may be applied between the left neighboring sample and prediction samples on the left boundary, thereby mitigating the discontinuity. The smoothing filter may not only increase prediction accuracy but also improve subjective/objective image quality.

However, the foregoing intra-post-filtering method is applied only to the boundary of a block in a spatial domain and has low accuracy in specific processing of each frequency component of a prediction block that may vary according to the prediction mode. Since intra-prediction is performed using a sample in an already reconstructed region of a current picture as a reference sample, the quality of the prediction may depend on the accuracy of a reconstructed sample. If noise occurs in the reference sample, this noise may be reflected in a subsequently predicted block, and it is difficult to effectively remove the noise by the foregoing intra-post-filtering method. Hereinafter, a frequency component may include a transform coefficient.

Since noise is generally part of a high-frequency component, processing in a frequency domain is required in order to properly separate and remove the noise. The disclosure proposes a method for improving prediction performance through frequency domain filtering. In this case, filtering may be performed using frequency domain information about an original image, thereby improving the accuracy of a prediction block (prediction samples). According to the disclosure, a method of applying frequency domain filtering to an intra-prediction block may be referred to as an intra-prediction frequency domain filtering method.

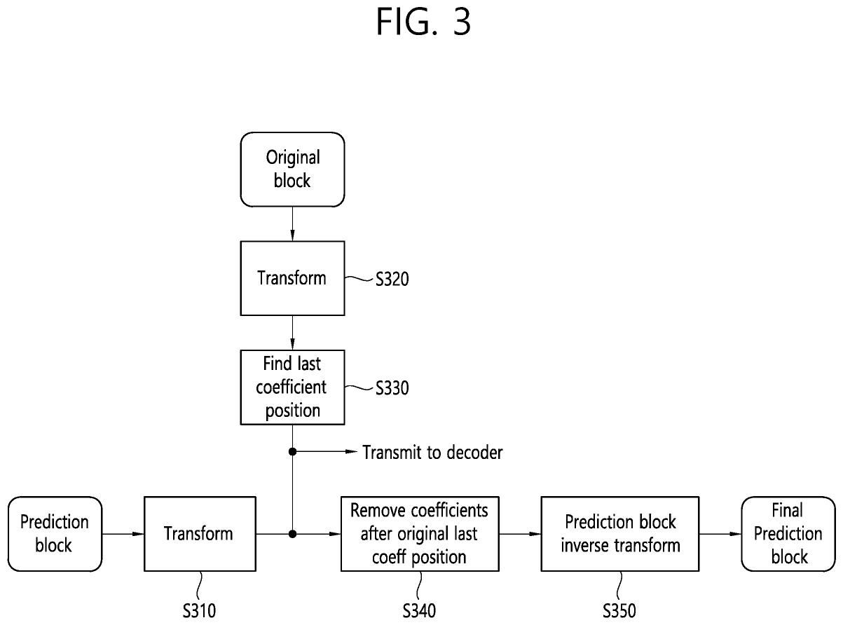

FIG. 3 illustrates an example of a frequency domain filtering method by an encoding device. The method disclosed in FIG. 3 may be performed by the predictor of the encoding device described above with reference to FIG. 1. Here, the predictor may include an intra-predictor, a transformer, a filter, and an inverse transformer. In this case, a prediction block of FIG. 3 may be obtained by the intra-predictor based on an intra-prediction mode and neighboring reference samples; S310 and S320 may be performed by the transformer; S330 and S340 may be performed by the filter; and S350 may be performed by the inverse transformer. The transformer, the filter, and the inverse transformer may be referred to as a prediction transformer, a prediction filter, and an inverse prediction transformer, respectively, which applies to the following description.

Referring to FIG. 3, the encoding device transforms the prediction block (S310). The prediction block includes prediction samples (a prediction sample array) derived using (reconstructed) neighboring reference samples based on a predetermined intra-prediction mode. If there is noise in the (reconstructed) neighboring reference samples, the noise spreads to the prediction block, thus affecting the accuracy of the prediction block. Alternatively, when a method of filtering or interpolating neighboring reference samples and deriving a prediction block using the filtered or interpolated neighboring reference samples according to a predetermined intra-prediction mode is used, an artifact that is not found in an original image may occur due to the characteristics of the method. Artifacts may mostly exist as noise of high-frequency components and may thus be effectively removed in the frequency domain. Therefore, according to the disclosure, the encoding device converts the prediction samples in the prediction block to derive transform coefficients of the frequency domain. The transform coefficients may be referred to as transform coefficients for the prediction block (prediction samples). This transformation may be performed using a discrete sine transform (DST) kernel or a discrete cosine transform (DCT) kernel.

To utilize frequency domain information about the original image, the encoding device transforms an original block corresponding to the prediction block (S320). The original block includes original samples of an original picture. The encoding device may transform the original samples in the original block to derive transform coefficients of the frequency domain. The transform coefficients may be referred to as transform coefficients for the original block (original samples). This transformation may be performed using a DST kernel or a DCT kernel.

When the original image (i.e., the original samples in the original block) is converted into the frequency domain, the original image is represented with individual frequency components decorrelated. Generally, when an image is converted into the frequency domain, the magnitude decreases as the frequency shifts from a low-frequency component to a high-frequency component. Similarly, when the prediction block is converted, significant information is also compacted to low-frequency components. Therefore, if a high-frequency component of the prediction block is a component that cannot be found in the transformation of the original block, the high-frequency component may be determined as noise and may be removed, thereby increasing the accuracy of the prediction block.

The encoding device may transmit information about the transformation of the original block to a decoding device. For example, the encoding device may detect position information about the last non-zero high-frequency component (position information about the last non-zero transform coefficient) among the transform coefficients for the original block (transform coefficients derived through transformation of the original block) (S330) and may transmit the position information to the decoding device. The position of the last non-zero high-frequency component may be represented based on a scan order (horizontal, vertical, diagonal, or the like) in which frequency components are scanned or based on the phase (coordinates) of a sample. The position of the last non-zero high-frequency component for the original block may be referred to as an original last coefficient position.

The encoding device removes transform coefficients corresponding to or mapped to a region after the position of the last non-zero high-frequency component among the transform coefficients for the original block among the transform coefficients for the prediction block (transform coefficients derived through the transformation of the prediction block) (S340). That is, the encoding device sets the values of the transform coefficients after the original last coefficient position among the transform coefficients for the prediction block to 0, which may be referred to as frequency domain filtering. Accordingly, it is possible to effectively remove high-frequency noise components, which do not exist in the original block, and to obtain modified transform coefficients for the prediction block.

The encoding device performs inverse transformation on the modified transform coefficients for the prediction block, thereby deriving a modified prediction block (S350). The modified prediction block may be used as a final prediction block.

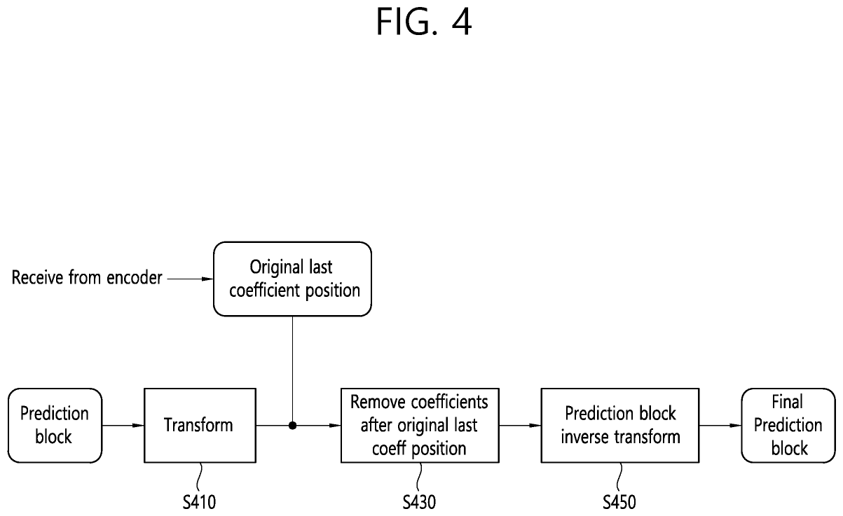

FIG. 4 illustrates an example of a frequency domain filtering method by a decoding device. The method disclosed in FIG. 4 may be performed by the predictor of the decoding device described above with reference to FIG. 2. Here, the predictor may include an intra-predictor, a transformer, a filter, and an inverse transformer. In this case, a prediction block of FIG. 4 may be obtained by the intra-predictor based on an intra-prediction mode and neighboring reference samples; S410 may be performed by the transformer; S430 may be performed by the filter; and S450 may be performed by the inverse transformer. The transformer, the filter, and the inverse transformer may be referred to as a prediction transformer, a prediction filter, and an inverse prediction transformer, respectively.

Referring to FIG. 4, the decoding device transforms the prediction block (S410). The prediction block includes prediction samples (a prediction sample array) derived using (reconstructed) neighboring reference samples based on a predetermined intra-prediction mode. The decoding device may convert the prediction samples in the prediction block to derive transform coefficients of the frequency domain. The transform coefficients may be referred to as transform coefficients for the prediction block (prediction samples). This transformation may be performed using a DST kernel or a DCT kernel.

The decoding device may receive information about the transformation of an original block from an encoding device. For example, the information about the transformation of the original block may include position information about the last non-zero high-frequency component (position information about the last non-zero transform coefficient) among the transform coefficients for the original block (transform coefficients derived through transformation of the original block). The position of the last non-zero high-frequency component may be represented based on a scan order (horizontal, vertical, zigzag diagonal, or the like) in which frequency components are scanned or based on the phase (coordinates) of a sample. As described above, the position of the last non-zero high-frequency component for the original block may be referred to as an original last coefficient position.

The decoding device removes transform coefficients corresponding to or mapped to a region after the position of the last non-zero high-frequency component among the transform coefficients for the original block among the transform coefficients for the prediction block (transform coefficients derived through the transformation of the prediction block) based on the information about the transformation of the original block (position information about the last non-zero high-frequency component for the original block) (S430). That is, the decoding device sets the values of the transform coefficients after the position of the last non-zero high-frequency component among the transform coefficients for the prediction block to 0. In this case, the transform coefficients after the position of the last non-zero high-frequency component among the transform coefficients for the prediction block may be derived based on the scan order. The decoding device may remove high-frequency components, which are not found in an original image, based on the information about the transformation of the original block (position information about the last non-zero high-frequency component for the original block), thereby performing frequency domain filtering on the prediction block and increasing the accuracy of the prediction block.

The decoding device performs inverse transformation on the modified transform coefficients for the prediction block, thereby deriving a modified prediction block (S450). The modified prediction block may be used as a final prediction block.

It may be explicitly signaled through flag information (e.g., a frequency domain filtering flag) or may be implicitly determined according to a predetermined particular condition whether to apply the frequency domain filtering method according to the foregoing embodiment. For example, the particular condition may be set based on at least one of the size of a target block, a prediction mode, the number of valid frequency components in the case where a prediction block is frequency-converted, and the complexity of a reference sample. Alternatively, the particular condition may be a condition for signaling the flag information, the flag information may be signaled only when the particular condition is satisfied, and it is possible to finally determine whether to apply the intra-prediction frequency domain filtering method based on the signaled information, thus reducing the number of bits required for transmission.

The foregoing embodiment is an example. In applying frequency domain filtering according to the disclosure, it is also possible to determine a particular frequency component (particular transform coefficient) in the frequency domain without transforming the original block and to filter transform coefficients for the prediction block based on the position of the particular frequency component (particular transform coefficient). Alternatively, it is possible to determine a particular frequency component region in the frequency domain and to remove transform coefficients in the particular frequency component region or transform coefficients outside the particular frequency component region. As described above, generally, when an image is converted into the frequency domain, the magnitude decreases as the frequency shifts from a low-frequency component to a high-frequency component. Similarly, when the prediction block is converted, significant information is also compacted to low-frequency components. Human eyes are more sensitive to low-frequency components than high-frequency components and may thus frequently have difficulty in clear recognition even though the high-frequency components are removed. Since the high-frequency components substantially include unnecessary elements, such as noise, together with information for representing details of an image, some high-frequency components are removed, thereby expecting a smoothing effect without significant deterioration in image quality.

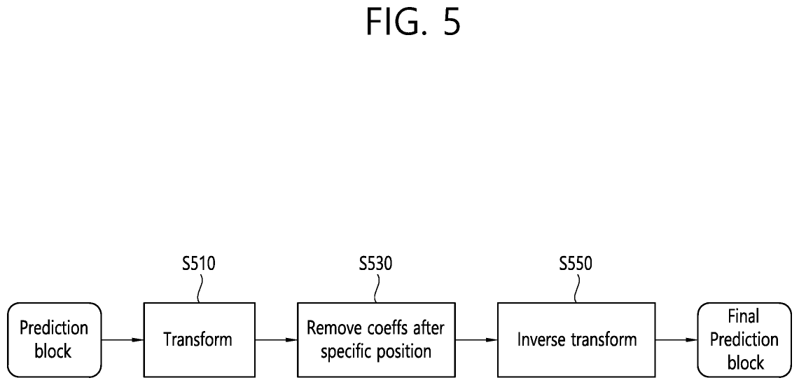

FIG. 5 illustrates another example of a frequency domain filtering method. The method disclosed in FIG. 5 may be performed by a coding device. The coding device may include an encoding device and a decoding device. In this case, a predictor of the encoding device/decoding device may include an intra-predictor, a transformer, a filter, and an inverse transformer. In this case, a prediction block of FIG. 5 may be obtained by the intra-predictor based on an intra-prediction mode and neighboring reference samples; S510 may be performed by the transformer; S530 may be performed by the filter; and S550 may be performed by the inverse transformer. The transformer, the filter, and the inverse transformer may be referred to as a prediction transformer, a prediction filter, and an inverse prediction transformer, respectively.

Referring to FIG. 5, the coding device transforms the prediction block (S510). The prediction block includes prediction samples (a prediction sample array) derived using (reconstructed) neighboring reference samples based on a predetermined intra-prediction mode. The coding device may convert the prediction samples in the prediction block to derive transform coefficients of the frequency domain. The transform coefficients may be referred to as transform coefficients for the prediction block (prediction samples). This transformation may be performed using a DST kernel or a DCT kernel.

The coding device may detect a particular frequency component position or a particular frequency component region according to a predetermined criterion and may perform filtering on transform coefficients for the prediction block based on the particular frequency component position or the particular frequency component region. (S530). The coding device may remove transform coefficients corresponding to or mapped to a region after the particular frequency component position. In this case, transform coefficients after the position of a particular frequency component (particular transform coefficient) among the transform coefficients for the prediction block may be derived based on a scan order. Alternatively, the coding device may remove transform coefficients within or outside the particular frequency component region.

In this case, the particular frequency component position or the particular frequency component region may be determined based on one of the following parameters or a combination of two or more thereof
Intra-prediction mode of block
Size of block (e.g. size of coding block or size of prediction unit)
Shape of block (e.g., square block or non-square block)
Type of transform kernel applied to block (e.g., DCT2, DST7, DCT8, DCT5, DST1, or the like)

For reference, the DCT/DST kernels may be defined based on basis functions, and the basis functions may be illustrated in the following table.

TABLE 1

| Transform Type | Basis function Tᵢ(j), i, j = 0, 1, . . . , N − 1 |
|---|---|
| DCT-II | $\begin{matrix}{T}_{i} ( j ) = {ω}_{0} \cdot \sqrt{\frac{2}{N}} \cdot cos ( \frac{π \cdot i \cdot ( 2 j + 1 )}{2 N} ) \\ where {ω}_{0} = \{ \begin{matrix}\sqrt{\frac{2}{N}} & i = 0 \\ 1 & i \neq 0\end{matrix}\end{matrix}$ |
| DCT-V | $\begin{matrix}{T}_{i} ( j ) = {ω}_{0} \cdot {ω}_{1} \cdot \sqrt{\frac{2}{2 N - 1}} \cdot cos ( \frac{2 π \cdot i \cdot j}{2 N - 1} ) , \\ where {ω}_{0} = \{ \begin{matrix}\sqrt{\frac{2}{N}} & i = 0 \\ 1 & i \neq 0\end{matrix} , {ω}_{1} = \{ \begin{matrix}\sqrt{\frac{2}{N}} & j = 0 \\ 1 & j \neq 0\end{matrix}\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-I | ${T}_{i} ( j ) = \sqrt{\frac{2}{N + 1}} \cdot sin ( \frac{π \cdot ( i + 1 ) \cdot ( j + 1 )}{N + 1} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

Scan pattern applied to block (horizontal scanning, vertical scanning, zigzag scanning, diagonal scanning, or the like)
Arbitrary determination based on image characteristics

For example, when the particular frequency component position or the particular frequency component region may be determined based on the intra-prediction mode, the following specific operation may be performed. When frequency conversion is performed in a mode having distinct characteristics, such as a DC mode, a horizontal mode, or a vertical mode, among intra-prediction modes, non-zero transform coefficients tend to be compacted to a particular frequency component. If block boundary filtering, which is the foregoing post-filtering method, is applied to these intra-prediction modes, an additional frequency component may further occur, but the transform coefficients generally tend to be weighted to any one-side frequency component. For example, in the horizontal mode, when the prediction block is converted into the frequency domain, non-zero transform coefficients tend to be compacted to a left frequency component of the block. Similarly, in the DC mode, non-zero transform coefficients are compacted to a DC component. In the vertical mode, non-zero transform coefficients are compacted to a top frequency component of the block. A frequency component (or the particular frequency component position or the particular frequency component region) taken for each mode may be determined using this tendency. For example, a block that has an N×N block size (e.g., N=8, 16, or the like) and has been predicted according to the vertical mode may be subjected to frequency conversion, after which only N×m frequency components (e.g., N=2, 4, or the like) may be taken, and the remaining components may be removed. Alternatively, a block that has an N×N block size and has been predicted according to the horizontal mode may be subjected to frequency conversion, after which only m×N frequency components (e.g., m=2) may be taken, and the remaining components may be removed. This method may be applied, for example, 1) only to a particular mode (the horizontal mode, the vertical mode, and the DC mode), or 2) to a directional mode and even to a neighboring mode (mode number ±1, ±2, ±3, or the like) of the directional mode.

In another example, when the particular frequency component position or the particular frequency component region may be determined based on the size of the block, the following specific operation may be performed. When intra-prediction is applied, since the prediction block is derived using a limited number of neighboring reference samples, it is possible to remove an unnecessary high-frequency component by imparting significance only to a particular frequency component. In this case, a frequency domain filtering region may be determined based on the number of pixels (samples) of the block. For example, according to a method, from a DC component to low-frequency components corresponding to half of the number of pixels in the block are maintained, and subsequent high-frequency components are removed. That is, in this case, from the DC component to the low-frequency components corresponding to half of the number of pixels in the block may be determined as particular frequency components, or a region including from the DC component to the low-frequency components corresponding to half of the number of pixels in the block may be determined as a particular frequency component region. Here, a scan order used for reconstructing a residual signal for a target block may be utilized. In this case, the number of pixels considered for maintaining/removing a frequency component may be variably determined according to the size of the block. For example, as many frequency components as up to half of the number of pixels may be maintained for a block of 16×16 or less, and as many frequency components as up to ¼ of the number of pixels in a block may be maintained for a block larger than 16×16.

In still another example, when the particular frequency component position or the particular frequency component region may be determined based on the characteristics of an image, the following specific operation may be performed. When intra-prediction is applied, since the prediction block is derived using a limited number of neighboring reference samples, it is possible to remove an unnecessary high-frequency component by imparting significance only to a particular frequency component. In this case, a frequency domain filtering region may be determined based on the number of frequency components. The encoding device may calculate the optimal number of frequency components and may transmit the calculated number to the decoding device. The encoding device may determine the minimum number of low-frequency components to be maintained in terms of rate-distortion (RD) and may transmit information about the last non-zero frequency component to the decoding device, thereby increasing the accuracy of the prediction block. The information about the last non-zero frequency component may be represented based on the scan order of frequency components or may be represented by block coordinate information. The decoding device may perform frequency domain filtering by removing a high-frequency component of the frequency-converted prediction block based on the received position information about the last non-zero frequency component.

Further, a frequency component to be removed and a frequency component to be maintained may be determined based on the magnitude of a frequency component.

For example, a frequency component having a specified magnitude or greater among frequency components after the position of a particular frequency component may be determined not as a noise component and may thus be maintained rather than being removed. In addition, the particular frequency component may be determined based on the magnitude of the frequency component. For example, a first frequency component having a specified magnitude or greater may be detected as the particular frequency component while performing a search in the reverse scan order from the bottom right position of the target block, and filtering may be performed on transform coefficients for the prediction block based on the position as described above.

The specified magnitude may be determined by various methods. For example, the specified magnitude may be predefined between the encoding device and the decoding device. Alternatively, the encoding device may determine the specified magnitude based on the RD cost and may transmit the specified magnitude to the decoding device. In this case, a unit for transmission may be a coding block (e.g., a coding block header), a slice (e.g., a slice header), a picture (e.g., a picture parameter set), an image sequence (e.g., a sequence parameter set), or a video (e.g., a video parameter set).

The coding device performs inverse transformation on the modified transform coefficients for the prediction block, thereby deriving a modified prediction block (S550). The modified prediction block may be used as a final prediction block.

It may be explicitly signaled through flag information (e.g., a frequency domain filtering flag) or may be implicitly determined according to a predetermined particular condition whether to apply the frequency domain filtering method according to the foregoing embodiment. For example, the particular condition may be set based on at least one of the size of a target block, a prediction mode, the number of valid frequency components in the case where a prediction block is frequency-converted, and the complexity of a reference sample. Alternatively, the particular condition may be a condition for signaling the flag information, the flag information may be signaled only when the particular condition is satisfied, and it is possible to finally determine whether to apply the intra-prediction frequency domain filtering method based on the signaled information, thus reducing the number of bits required for transmission.

In applying frequency domain filtering according to the disclosure, a mask may be defined to perform filtering of maintaining particular frequency components and removing the remaining frequency components.

As described above, the prediction block is derived with reference to (reconstructed) neighboring reference samples. If there is noise in the (reconstructed) neighboring reference samples, the noise spreads to the prediction block, thus affecting the accuracy of the prediction block. Alternatively, when a method of filtering or interpolating neighboring reference samples and deriving a prediction block using the filtered or interpolated neighboring reference samples according to a predetermined intra-prediction mode is used, an artifact that is not found in an original image may occur due to the characteristics of the method. Artifacts may mostly exist as noise of high-frequency components and may thus be effectively removed in the frequency domain. Therefore, for efficient frequency domain filtering, a mask may be defined to perform filtering of maintaining particular frequency components and removing the remaining frequency components. The mask may be determined by various methods based on an intra-prediction mode or a block size. As described above, when the original image is converted into the frequency domain, the original image is represented with individual frequency components decorrelated. Generally, when an image is converted into the frequency domain, the magnitude decreases as the frequency shifts from a low-frequency component to a high-frequency component. Similarly, when the prediction block is converted, significant information is also compacted to low-frequency components. Human eyes are more sensitive to low-frequency components than high-frequency components and may thus frequently have difficulty in clear recognition even though the high-frequency components are removed. Since the high-frequency components substantially include unnecessary elements, such as noise, together with information for representing details of an image, some high-frequency components are removed, thereby expecting a smoothing effect without significant deterioration in image quality. In this case, a mask for maintaining a significant frequency component and removing relatively insignificant frequency information may be defined based on various factors, such as the distance from a reference sample, a correlation with original information, prediction mode information, a block size, and the like.

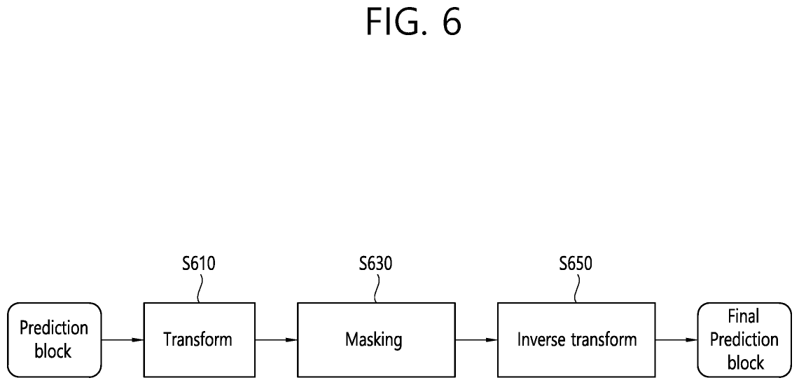

FIG. 6 illustrates still another example of a frequency domain filtering method. The method disclosed in FIG. 6 may be performed by a coding device. The coding device may include an encoding device and a decoding device. In this case, a predictor of the encoding device/decoding device may include an intra-predictor, a transformer, a filter, and an inverse transformer. In this case, a prediction block of FIG. 6 may be obtained by the intra-predictor based on an intra-prediction mode and neighboring reference samples; S610 may be performed by the transformer; S630 may be performed by the filter; and S650 may be performed by the inverse transformer. The transformer, the filter, and the inverse transformer may be referred to as a prediction transformer, a prediction filter, and an inverse prediction transformer, respectively.

Referring to FIG. 6, the coding device transforms the prediction block (S610). The prediction block includes prediction samples (a prediction sample array) derived using (reconstructed) neighboring reference samples based on a predetermined intra-prediction mode. The coding device may convert the prediction samples in the prediction block to derive transform coefficients of the frequency domain. The transform coefficients may be referred to as transform coefficients for the prediction block (prediction samples). This transformation may be performed using a DST kernel or a DCT kernel.

The coding device may perform frequency domain filtering by masking the transform coefficients for the prediction block based on a mask (S630). The mask may be a binary mask including a plurality of 0s or 1s. The mask may have the same size as the size of the prediction block. In this case, the coding device may compare frequency components (transform coefficients or transform coefficient array) for the prediction block with the mask on a phase basis, thus maintaining a frequency component (transform coefficient) mapped to a region having a mask component value of 1 and removing a frequency component mapped to a region having a mask component value of 0. Information about the mask may be predefined between the encoding device and the decoding device, or may be generated by the encoding device to be transmitted to the decoding device. The information about the mask may be transmitted through a video parameter set, a sequence parameter set, a picture parameter set, or a slice header.

For example, the mask may be determined and signaled by the encoding device based on the RD cost. In this case, index information indicating one mask in a predefined mask candidate list may be signaled.

Alternatively, the mask may be adaptively determined based on various factors, such as the distance from a reference sample, a correlation with original information, prediction mode information, a block size, and the like. In this case, trained information obtained from images having various characteristics may be utilized. For example, the mask may be determined based on a (intra-) prediction mode and a block size. A correlation between a prediction block and an original block according to a prediction mode and a block size used when encoding an image is trained in various cases, after which a mask according to a combination of each (intra-) prediction mode and a block size may be defined. For example, a correlation (e.g., Pearson correlation) between a prediction block and an original block for each frequency component is calculated, after which a frequency component having a correlation of a threshold value or greater may be determined as significant information. The prediction block is converted into the frequency domain, after which a mask suitable for a prediction mode and a block size is applied thereto, thereby maintaining only a frequency component having a high correlation with the original block and obtaining a smooth filtering effect.

The coding device performs inverse transformation on the modified transform coefficients for the prediction block, thereby deriving a modified prediction block (S650). The modified prediction block may be used as a final prediction block.

It may be explicitly signaled through flag information (e.g., a frequency domain filtering flag) or may be implicitly determined according to a predetermined particular condition whether to apply the frequency domain filtering method according to the foregoing embodiment. For example, the particular condition may be set based on at least one of the size of a target block, a prediction mode, the number of valid frequency components in the case where a prediction block is frequency-converted, and the complexity of a reference sample. Alternatively, the particular condition may be a condition for signaling the flag information, the flag information may be signaled only when the particular condition is satisfied, and it is possible to finally determine whether to apply the intra-prediction frequency domain filtering method based on the signaled information, thus reducing the number of bits required for transmission.

For the frequency domain filtering (or noise filtering) performed in the foregoing embodiments, the transformation (e.g., S310, S410, S510, and S610)/inverse transformation (S350, S450, S550, and S650) may be performed based on various transformation methods. For example, one predefined transform kernel (e.g., one of DCT2, DST7, DCT8, DCT5, DST1, and the like) may be used. In the existing video coding standards, only inverse transformation is defined. Thus, it is necessary to newly define a corresponding transformation method. When a single predefined transform kernel is used, a transformation method may be simply defined and may be effective in using a memory for storing transform-related information. In another example, a transform kernel applied for processing a residual signal as described above with reference to FIG. 1 and FIG. 2 (i.e., a transformation method used for converting a residual sample) may be used. In this case, it is possible to obtain more precise noise filtering performance and to provide higher compression efficiency.

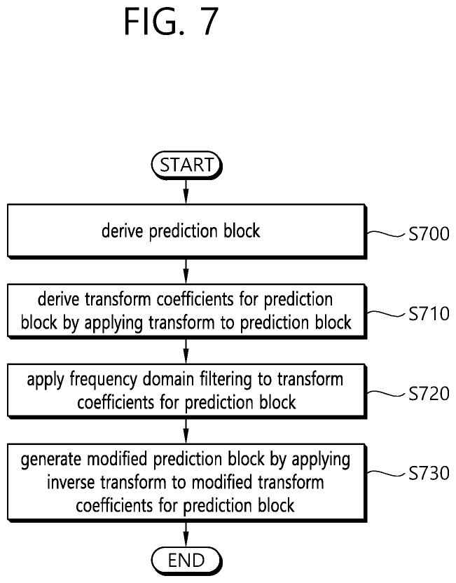

FIG. 7 schematically illustrates a video/image encoding method including a frequency domain filtering method according to the disclosure. The method disclosed in FIG. 7 may be performed by the encoding device disclosed in FIG. 1. Specifically, for example, S700 to S730 of FIG. 7 may be performed by the predictor of the encoding device. In detail, the predictor may include an intra-predictor, a (prediction) transformer, a (prediction) filter, and a (prediction) inverse transformer; S700 may be performed by the intra-predictor; S710 may be performed by the (prediction) transformer; S720 may be performed by the (prediction) filter; and S730 may be performed by the (prediction) inverse transformer.

Referring to FIG. 7, the encoding device derives a prediction block for a current block (S700). The prediction block includes prediction samples (prediction sample array) for the current block. The encoding device may derive the prediction samples using reconstructed neighboring reference samples in a current picture based on an intra-prediction mode for the current block.

The encoding device derives transform coefficients (frequency components) for the prediction block through transformation of the prediction block (i.e., transformation of the prediction samples) (S710). The transformation may be performed using a DST kernel or a DCT kernel. For example, the transformation is performed based on a particular transform kernel, and the particular transform kernel may be one of DCT2, DST7, DCT8, DCT5, and DST1. In another example, the particular transform kernel may be the same transform kernel as used in the inverse transformation procedure of transform coefficients for a residual signal for the current block.

The encoding device applies frequency domain filtering to the transform coefficients for the prediction block (S720). Through the frequency domain filtering, modified transform coefficients for the prediction block may be derived. Here, the modified transform coefficients may include transform coefficients having a value changed after filtering and transform coefficients having an unchanged value.

For example, the encoding device may determine, as a particular transform coefficient position, the position of the last non-zero transform coefficient detected according to the scan order among transform coefficients for an original block derived through transformation of the original block corresponding to the prediction block and may remove transform coefficients after the particular transform coefficient position based on a particular scan order. That is, the encoding device may set the values of the transform coefficients after the particular transform coefficient position to 0 based on the particular scan order. In this case, the encoding device may generate information indicating the particular transform coefficient position and may signal the information to a decoding device. The particular scan order may be one of a horizontal scan order, a vertical scan order, a zigzag scan order, and a diagonal scan order. The particular scan order may be determined based on the intra-prediction mode.

In another example, the encoding device may determine a particular transform coefficient position based on at least one of the intra-prediction mode, the size of the current block, the shape of the current block, a transform kernel applied for processing a residual signal for the current block, the scan order of the current block, and an image characteristic and may set the values of transform coefficients after the particular transform coefficient position to 0 based on a particular scan order. For example, the particular transform coefficient position may be determined based on the intra-prediction mode. In this case, when the intra-prediction mode is the vertical mode, the particular transform coefficient position may be the position of the last transform coefficient in an mth row among the transform coefficients and may set the values of transform coefficients in rows after the mth row among the transform coefficients to 0. When the intra-prediction mode is the horizontal mode, the particular transform coefficient position may be the position of the last transform coefficient in an mth column among the transform coefficients and may set the values of transform coefficients in columns after the mth column among the transform coefficients to 0. In another example, the particular transform coefficient position may be determined based on the size of the current block, the size of the current block may be represented by the number of pixels in the current block, and the position of a transform coefficient corresponding to ½ or ¼ of the number of pixels based on the scan order may be determined as the particular transform coefficient position. For example, when the current block has a size of 16×16 or less, the position of the transform coefficient corresponding to ½ of the number of pixels may be determined as the particular transform coefficient position; when the current block has a size of 16×16 or greater, the position of the transform coefficient corresponding to ¼ of the number of pixels may be determined as the particular transform coefficient position. In still another example, the encoding device may determine the minimum number of low-frequency components to be maintained in terms of the RD cost based on an image characteristic and may then determine the particular transform coefficient position based on the minimum number of low-frequency components. In yet another example, the particular transform coefficient position (according to the scan order) may be predefined for each mode and each block size in a table, and the encoding device and the decoding device may derive the particular transform coefficient position with reference to the table. The particular transform coefficient position may indicate the position of the last non-zero transform coefficient. In this case, as described above, it may be determined whether to use the method based on flag information.

The encoding device may determine a particular transform coefficient magnitude and may not set the value of a transform coefficient having a magnitude equal to or greater than the particular transform coefficient magnitude to 0. For example, the value of a transform coefficient having a magnitude equal to or greater than the particular transform coefficient magnitude among the transform coefficients after the particular transform coefficient position may not be set to 0. The particular magnitude may be predefined between the encoding device and the decoding device. Alternatively, the particular magnitude may be determined by the encoding device based on the RD cost and may be transmitted to the decoding device.

In another example, the encoding device may determine a mask for the frequency domain filtering and may set the values of transform coefficients not belonging to the mask to 0. The mask may be a binary mask including 0s or 1s. The mask may have the same size as that of the prediction block. In this case, the encoding device may compare frequency components (transform coefficients or transform coefficient array) for the prediction block with the mask on a phase basis, thus maintaining a frequency component (transform coefficient) mapped to a region having a mask component value of 1 and removing a frequency component mapped to a region having a mask component value of 0. For example, the mask may be determined and signaled by the encoding device based on the RD cost. In this case, index information indicating one mask in a predefined mask candidate list may be signaled. Alternatively, the mask may be adaptively determined based on various factors, such as the distance from a reference sample, a correlation with original information, prediction mode information, a block size, and the like.

The encoding device may indicate whether to apply the frequency domain filtering based on a predetermined condition or a frequency domain filtering flag. For example, the encoding device may determine a frequency domain filtering availability condition, and may generate and signal a frequency domain filtering flag to the decoding device when the frequency domain filtering availability condition is satisfied.

The encoding device applies inverse transformation to the modified transform coefficients for the prediction block and generates a modified prediction block (S730). The modified prediction block includes modified prediction samples. The inverse transformation may be performed using a DST kernel or a DCT kernel. For example, the inverse transformation is performed based on a particular transform kernel, and the particular transform kernel may be one of DCT2, DST7, DCT8, DCT5, and DST1. In another example, the particular transform kernel may be the same transform kernel as used in the inverse transformation procedure of transform coefficients for a residual signal for the current block.

The encoding device may further derive a residual block between the original block and the predicted block, may transform residual samples (residual sample array) included in the residual block to derive transform coefficients, may quantize the transform coefficients to derive quantized transform coefficients, and may signal related residual information to the decoding device (via a bitstream). Here, the residual information may include value information, position information, a transformation scheme, a transform kernel, and a quantization parameter of the quantized transform coefficients. A reconstructed block and a reconstructed picture may be generated based on the residual block and the modified prediction block.

The encoding device may encode and output the information generated in the above-described procedure. The encoding device may output the encoded information in the form of a bitstream. The bitstream may be transmitted to the decoding device via a network or a storage medium.

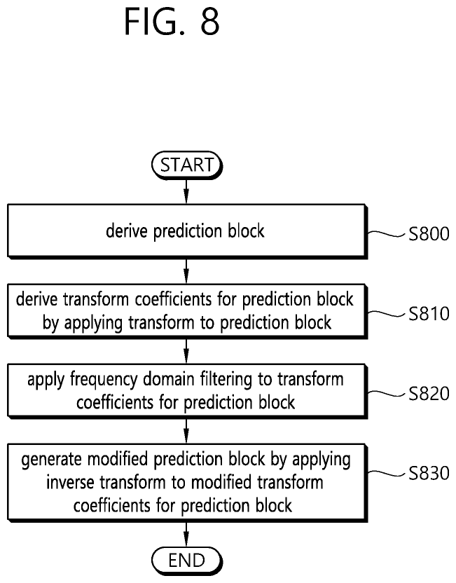

FIG. 8 schematically illustrates a video/image decoding method including a frequency domain filtering method according to the disclosure. The method disclosed in FIG. 8 may be performed by the decoding device illustrated in FIG. 2. Specifically, for example, S800 to S830 of FIG. 8 may be performed by the predictor of the decoding device. In detail, the predictor may include an intra-predictor, a (prediction) transformer, a (prediction) filter, and a (prediction) inverse transformer; S800 may be performed by the intra-predictor; S810 may be performed by the (prediction) transformer; S820 may be performed by the (prediction) filter; and S830 may be performed by the (prediction) inverse transformer.

Referring to FIG. 8, the decoding device derives a prediction block for a current block (S800). The prediction block includes prediction samples (prediction sample array) for the current block. The decoding device may derive the prediction samples using reconstructed neighboring reference samples in a current picture based on an intra-prediction mode for the current block.

The decoding device derives transform coefficients (frequency components) for the prediction block through transformation of the prediction block (i.e., transformation of the prediction samples) (S810). The transformation may be performed using a DST kernel or a DCT kernel. For example, the transformation is performed based on a particular transform kernel, and the particular transform kernel may be one of DCT2, DST7, DCT8, DCT5, and DST1. In another example, the particular transform kernel may be the same transform kernel as used in the inverse transformation procedure of transform coefficients for a residual signal for the current block.

The decoding device applies frequency domain filtering to the transform coefficients for the prediction block (S820). Through the frequency domain filtering, modified transform coefficients for the prediction block may be derived. Here, the modified transform coefficients may include transform coefficients having a value changed after filtering and transform coefficients having an unchanged value.

For example, the decoding device may receive information indicating a particular transform coefficient position and may remove transform coefficients after the particular transform coefficient position based on a particular scan order. That is, the decoding device may set the values of the transform coefficients after the particular transform coefficient position to 0 based on the particular scan order. The particular transform coefficient position may be correspond to the position of the last non-zero transform coefficient detected according to the scan order among transform coefficients for an original block derived through transformation of the original block corresponding to the prediction block. The particular scan order may be one of a horizontal scan order, a vertical scan order, a zigzag scan order, and a diagonal scan order. The particular scan order may be determined based on the intra-prediction mode.

In another example, the decoding device may determine a particular transform coefficient position based on at least one of the intra-prediction mode, the size of the current block, the shape of the current block, a transform kernel applied for processing a residual signal for the current block, the scan order of the current block, and an image characteristic and may set the values of transform coefficients after the particular transform coefficient position to 0 based on a particular scan order. For example, the particular transform coefficient position may be determined based on the intra-prediction mode. In this case, when the intra-prediction mode is the vertical mode, the particular transform coefficient position may be the position of the last transform coefficient in an mth row among the transform coefficients and may set the values of transform coefficients in rows after the mth row among the transform coefficients to 0. When the intra-prediction mode is the horizontal mode, the particular transform coefficient position may be the position of the last transform coefficient in an mth column among the transform coefficients and may set the values of transform coefficients in columns after the mth column among the transform coefficients to 0. In another example, the particular transform coefficient position may be determined based on the size of the current block, the size of the current block may be represented by the number of pixels in the current block, and the position of a transform coefficient corresponding to ½ or ¼ of the number of pixels based on the scan order may be determined as the particular transform coefficient position. For example, when the current block has a size of 16×16 or less, the position of the transform coefficient corresponding to ½ of the number of pixels may be determined as the particular transform coefficient position; when the current block has a size of 16×16 or greater, the position of the transform coefficient corresponding to ¼ of the number of pixels may be determined as the particular transform coefficient position. In still another example, the particular transform coefficient position may be determined by an encoding device based on an image characteristic and may be signaled to the decoding device. In yet another example, the particular transform coefficient position (according to the scan order) may be predefined for each mode and each block size in a table, and the encoding device and the decoding device may derive the particular transform coefficient position with reference to the table. The particular transform coefficient position may indicate the position of the last non-zero transform coefficient. In this case, as described above, it may be determined whether to use the method based on flag information.

The decoding device may determine a particular transform coefficient magnitude and may not set the value of a transform coefficient having a magnitude equal to or greater than the particular transform coefficient magnitude to 0. For example, the value of a transform coefficient having a magnitude equal to or greater than the particular transform coefficient magnitude among the transform coefficients after the particular transform coefficient position may not be set to 0. The particular magnitude may be predefined between the encoding device and the decoding device. Alternatively, the particular magnitude may be determined by the encoding device based on the RD cost and may be transmitted to the decoding device.

In another example, the decoding device may determine a mask for the frequency domain filtering and may set the values of transform coefficients not belonging to the mask to 0. The mask may be a binary mask including 0s or 1s. The mask may have the same size as that of the prediction block. In this case, the encoding device may compare frequency components (transform coefficients or transform coefficient array) for the prediction block with the mask on a phase basis, thus maintaining a frequency component (transform coefficient) mapped to a region having a mask component value of 1 and removing a frequency component mapped to a region having a mask component value of 0. For example, the mask may be determined by the encoding device based on the RD cost and may be signaled to the decoding device. In this case, index information indicating one mask in a predefined mask candidate list may be signaled. Alternatively, the mask may be adaptively determined based on various factors, such as the distance from a reference sample, a correlation with original information, prediction mode information, a block size, and the like.

The decoding device may determine whether to apply the frequency domain filtering based on a predetermined condition or a frequency domain filtering flag. For example, the decoding device may determine a frequency domain filtering availability condition, and may receive a frequency domain filtering flag and may determine whether to apply the frequency domain filtering based on the frequency domain filtering flag when the frequency domain filtering availability condition is satisfied.

The decoding device applies inverse transformation to the modified transform coefficients for the prediction block and generates a modified prediction block (S830). The modified prediction block includes modified prediction samples. The inverse transformation may be performed using a DST kernel or a DCT kernel. For example, the inverse transformation is performed based on a particular transform kernel, and the particular transform kernel may be one of DCT2, DST7, DCT8, DCT5, and DST1. In another example, the particular transform kernel may be the same transform kernel as used in the inverse transformation procedure of transform coefficients for a residual signal for the current block.

Although not shown, the decoding device may derive residual samples based on inverse transformation of transform coefficients for a residual signal, may generate reconstructed samples (reconstructed block) based on the modified prediction samples in the modified prediction block and the residual samples, and may reconstruct a picture based on the reconstructed samples.

Subsequently, as described above, the decoding device may apply an in-loop filtering procedure, such as deblocking filtering, an SAO procedure, and/or an ALF procedure, to the reconstructed picture if necessary in order to improve subjective/objected image quality.

The foregoing methods according to the disclosure may be implemented as a software form, and an encoding device and/or decoding device according to the disclosure may be included in a device for image processing, for example, a TV, a computer, a smartphone, a set-top box, and a display device.

When embodiments of the disclosure are implemented as software, the foregoing methods may be implemented as modules (processes or functions) to perform the foregoing functions. The modules may be stored in a memory and may be executed by a processor. The memory may be inside or outside the processor and may be connected to the processor via a well-known device. The processor may include an application-specific integrated circuit (ASIC), a different chipset, a logic circuit, and/or a data processor. The memory may include a read-only memory (ROM), a random access memory (RAM), a flash memory, a memory card, a storage medium, and/or another storage device.

What is claimed is:

1. A prediction method performed by a decoding device, the prediction method comprising:
deriving a prediction block based on an intra-prediction mode;
deriving transform coefficients for the prediction block by applying transformation to the prediction block;
applying frequency domain filtering to the transform coefficients for the prediction block; and
generating a modified prediction block by applying inverse transformation to modified transform coefficients derived through the frequency domain filtering.

2. The prediction method of claim 1, wherein the applying of the frequency domain filtering comprises:
receiving information indicating a particular transform coefficient position; and
setting values of transform coefficients after the particular transform coefficient position to 0 based on a scan order,
wherein the particular transform coefficient position corresponds to a position of a last non-zero transform coefficient detected according to the scan order among transform coefficients for an original block derived through transformation of the original block corresponding to the prediction block.

3. The prediction method of claim 2, wherein the scan order is one of a horizontal scan order, a vertical scan order, a zigzag scan order, and a diagonal scan order.

4. The prediction method of claim 3, wherein the scan order is determined based on the intra-prediction mode.

5. The prediction method of claim 1, wherein the applying of the frequency domain filtering comprises:
detecting a particular transform coefficient position; and
setting values of transform coefficients after the particular transform coefficient position to 0 based on a scan order,
wherein the particular transform coefficient position is determined based on at least one of the intra-prediction mode, a size of a current block, a shape of the current block, a transform kernel applied for processing a residual signal for the current block, a scan order of the current block, and an image characteristic.

6. The prediction method of claim 5, wherein the particular transform coefficient position is determined based on the intra-prediction mode, and
when the intra-prediction mode is a vertical mode, the particular transform coefficient position is a position of a last transform coefficient in an mth row among the transform coefficients, and values of transform coefficients in rows after the mth row among the transform coefficients are set to 0.

7. The prediction method of claim 5, wherein the particular transform coefficient position is determined based on the intra-prediction mode, and
when the intra-prediction mode is a horizontal mode, the particular transform coefficient position is a position of a last transform coefficient in an mth column among the transform coefficients, and values of transform coefficients in columns after the mth column among the transform coefficients are set to 0.

8. The prediction method of claim 5, wherein the particular transform coefficient position is determined based on the size of the current block,
the size of the current block is represented by a number of pixels in the current block, and
a position of a transform coefficient corresponding to ½ or ¼ of the number of pixels based on the scan order is determined as the particular transform coefficient position.

9. The prediction method of claim 5, wherein when the size of the current block is 16×16 or less, a position of a transform coefficient corresponding to ½ of the number of pixels is determined as the particular transform coefficient position;
when the size of the current block is 16×16 or greater, a position of a transform coefficient corresponding to ¼ of the number of pixels is determined as the particular transform coefficient position.

10. The prediction method of claim 5, further comprising determining or receiving information about a particular transform coefficient magnitude,
wherein a value of a transform coefficient having a magnitude equal to or greater than the particular transform coefficient magnitude among the transform coefficients after the particular transform coefficient position is not set to 0.

11. The prediction method of claim 5, further comprising:
determining a frequency domain filtering availability condition; and
receiving a frequency domain filtering flag when the frequency domain filtering availability condition is satisfied,
wherein it is determined whether to apply the frequency domain filtering based on the frequency domain filtering flag.

12. The method of claim 1, wherein the applying of the frequency domain filtering comprises:
determining a mask for the frequency domain filtering; and
setting values of transform coefficients not belonging to the mask to 0

13. The prediction method of claim 1, wherein the transformation applied to the prediction block and the inverse transformation applied to the modified transform coefficients are performed based on a particular transform kernel, and the particular transform kernel is one of DCT2, DST7, DCT8, DCT5, and DST1.

14. The prediction method of claim 1, further comprising:
deriving residual samples based on inverse transformation of transform coefficients for a residual signal; and
generating reconstructed samples based on modified prediction samples in the modified prediction block and the residual samples,
wherein the transformation applied to the prediction block and the inverse transformation applied to the modified transform coefficients are performed based on a particular transform kernel, and the particular transform kernel is the same transform kernel as used in an inverse transformation procedure of the transform coefficients for the residual signal for the current block

15. An image decoding device comprising:
an intra-predictor configured to derive a prediction block based on an intra-prediction mode;
a transformer configured to derive transform coefficients for the prediction block by applying transformation to the prediction block;
a filter configured to apply frequency domain filtering to the transform coefficients for the prediction block; and
an inverse transformer configured to generate a modified prediction block by applying inverse transformation to modified transform coefficients derived through the frequency domain filtering.
